(19) United States
(12) Patent Application Publication
(10) Pub. No.: US 2010/0011526 A1
(43) Pub. Date: Jan. 21, 2010

(54) Towel for material application to concave surfaces

(75) Inventors: Rudy Cantu, Mesa, AZ (US); Jennifer Cantu, Mesa, AZ (US)

Correspondence Address: DONALD J LENKSZUS, P O BOX 3064, CAREFREE, AZ, 85377-3064, US

(73) Assignee: CANTOOLS, INC.

(21) Appl. No.: 12/459,755

(22) Filed: Jul. 7, 2009

Related U.S. Application Data
(60) Provisional application No. 61/135,075, filed on Jul. 15, 2008.

(51) Int. Cl. B05C 17/10

(52) U.S. Cl. 15/235.4

(57) ABSTRACT

A trowel for working a curved surface is described. In one embodiment, a trowel comprises a relatively flexible sheet of material having a memory property tending to maintain the sheet in a planar configuration. The sheet has a leading edge, a trailing edge and first and second side edges connecting the leading edge and the trailing edge. The leading edge is arcuate between the first and second side edges. The trowel further comprises a handle coupled to the sheet at the trailing edge.

### RELATED APPLICATIONS

This application claims priority from U.S. Patent Application Ser. No. 61/135,075 filed on Jul. 15, 2008. The entirety of that application is incorporated herein by reference.

### FIELD

The invention pertains to hand tools, in general, and to a hand trowel for use in building and decorating, in particular.

### BACKGROUND

A trowel refers to a hand tool used to apply and spread various materials in various applications to build or decorate in or on a surface.

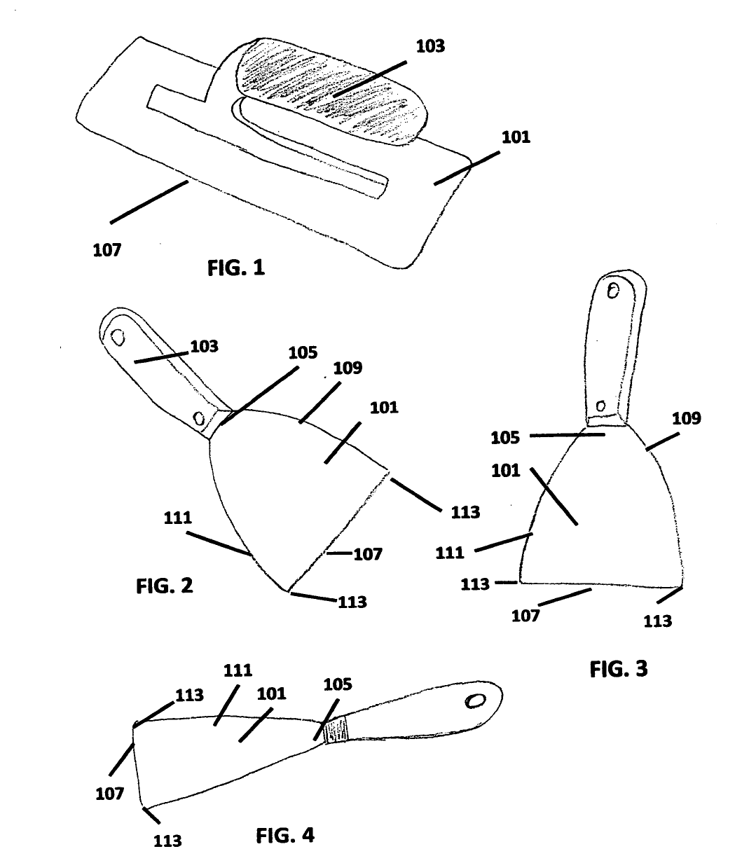

Flexible blade trowels are well known and are frequently utilized for the application of material to walls and ceilings and for the finishing of the material applied. Representative trowels are shown in FIGS. 1-4. Such trowels are used for application of material to walls and ceilings and working and finishing of material, typically comprise of a straight sharp edge blade 101 attached to a handle 103 extending from one end 105 of the blade 101. The leading edge 107 of the blade 101 meets with the side edges 109, 111 of the blade with either 90-degree corners or slightly rounded corners 113. The width and length of the blade 101 of the trowel is determined by the specific use of the trowel.

While the prior art trowels are useful in applying and working materials to a flat surface they have a significant disadvantage when used on concave or convex surfaces, such as arc or dome shaped walls or ceilings.

When such prior art trowels are used to work materials on concave or convex surfaces, the corners 113 of the prior art trowels generally cause scratching, gouging, and marring which reduces the quality of the finished surface. FIG. 5 illustrates the disadvantage of using a straight sharp edge trowel 500 on a concave surface such as in a dome. In FIG. 5, a cross-section of a dome wall 501 is shown. The corners 113 will cause gouges in the material applied to dome wall 501 or alternatively, a build up of material unevenly on the dome surface 503. It will be understood by those skilled in the art that the dimensions of the curved surface may differ widely from that shown, but FIG. 5 is provided to illustrate the problem that occurs when utilizing a prior art trowel to work the concave surface 503 of dome 501. A gap 505 occurs between the arced surface 503 of the wall 501 and the flat leading edge 101.

Prior art trowels are limited when applying materials to concave and convex surfaces; they do not efficiently transfer materials directly onto the surface and cannot apply the appropriate amount of pressure and control to meet the curvature of the surface.

It is desirable to provide a trowel or set of trowels that overcome the disadvantages associated with prior art trowels when used to apply various materials to concave or convex surfaces.

There is, therefore, a need for a flexible arced knife-edge trowel, which facilitates appropriate application of various materials without causing imperfections to concave and convex surfaces.

### SUMMARY

In accordance with the invention, a flexible arched trowel is provided. The trowel is used work various materials onto surfaces.

In accordance with the principles of the invention, a trowel for working a curved surface is provided. In one embodiment, a trowel comprises a relatively flexible sheet of material having a memory property tending to maintain the sheet in a planar configuration. The sheet has a leading edge, a trailing edge and first and second side edges connecting the leading edge and the trailing edge. The leading edge is arcuate between the first and second side edges. The trowel further comprises a handle coupled to the sheet at the trailing edge.

In an embodiment, the leading edge comprises rounded end portions adjacent each of the first and second side edges.

In an embodiment, the leading edge is convex with an arc of a predetermined radius over substantially the entire length of the leading edge.

In an embodiment, the material comprises steel. In another embodiment the material comprises plastic.

In an embodiment, the material is laser cut to provide the leading edge.

In an embodiment, the leading edge has an arc of a predetermined radius over substantially the entire length of said leading edge.

In an embodiment, the leading edge has an arc of a first predetermined radius over substantially the entire length of the leading edge and end portions each having a second predetermined radius selected to be substantially shorter than the first predetermined radius.

In an embodiment, the handle comprises plastic material. Still further, the handle is molded onto the flexible sheet of material.

In an embodiment, the leading edge is beveled.

In accordance with an aspect of the invention, a set of trowels for working a curved surface is provided and each of the trowels comprises: a relatively flexible sheet of material having a memory property tending to maintain the sheet in a planar configuration; the sheet having a leading edge, a trailing edge and first and second side edges connecting the leading edge and the trailing edge; the leading edges are arcuate between the first and second side edges; and a handle coupled to the sheet at said trailing edge. Each trowel has a different width.

In an embodiment of the invention, a trowel for working a curved surface comprises a relatively flexible sheet of material having a memory property tending to maintain the sheet in a planar configuration. The sheet has a leading edge, a trailing edge and first and second side edges connecting the leading edge and the trailing edge. The leading edge is convex between the first and second side edges with a predetermined radius selected to facilitate working a dome surface. The trowel further comprises a handle coupled to the sheet at the trailing edge.

### BRIEF DESCRIPTION

The invention will be better understood from reading of the following detailed description of embodiments of the invention in conjunction with the drawing figures, in which, like reference designators are utilized to identify like elements, and in which:

FIG. 1 is a drawing of a prior art Venetian plaster trowel blade and handle;

FIG. 2 is a drawing of a prior art joint knife blade and handle;

FIG. 3 is a drawing of a prior art joint knife blade and handle;

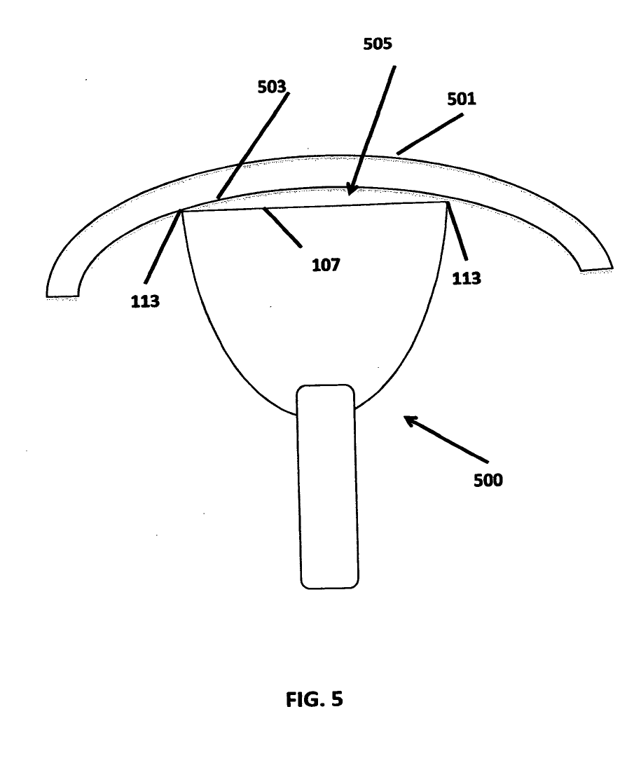

FIG. 4 is a drawing of a prior art putty knife blade and handle;

FIG. 5 is a drawing of the prior art trowel of FIG. 3, held adjacent to surface show in cross-section;

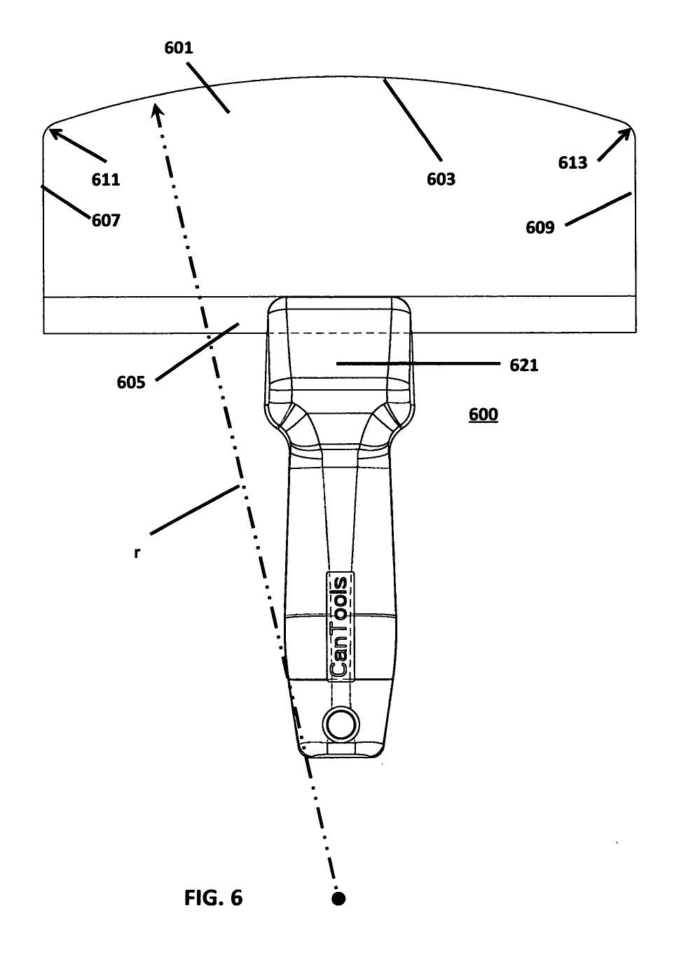

FIG. 6 is a planar view of an embodiment of the invention;

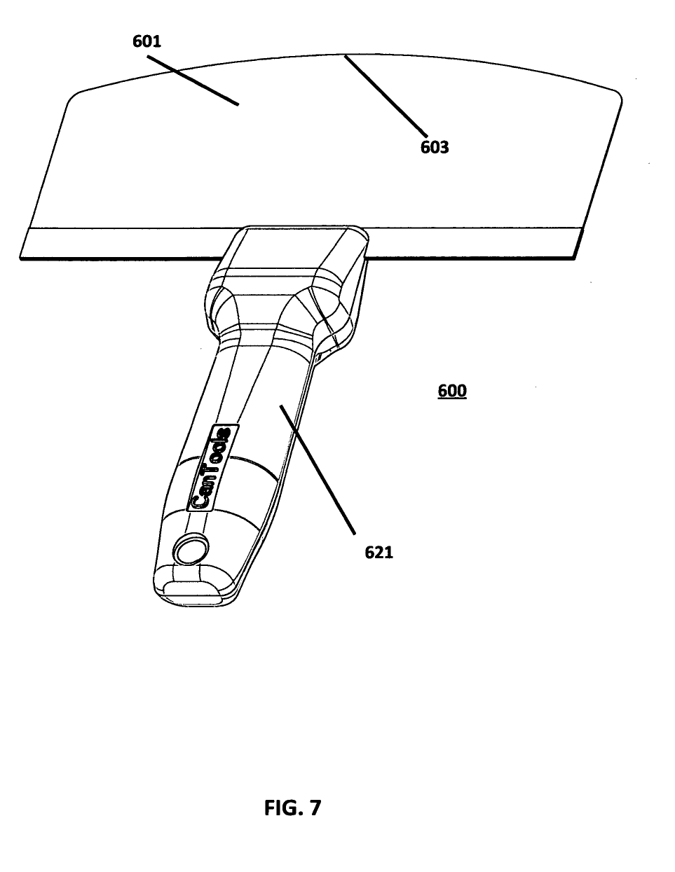

FIG. 7 is an isometric view of the embodiment of FIG. 6;

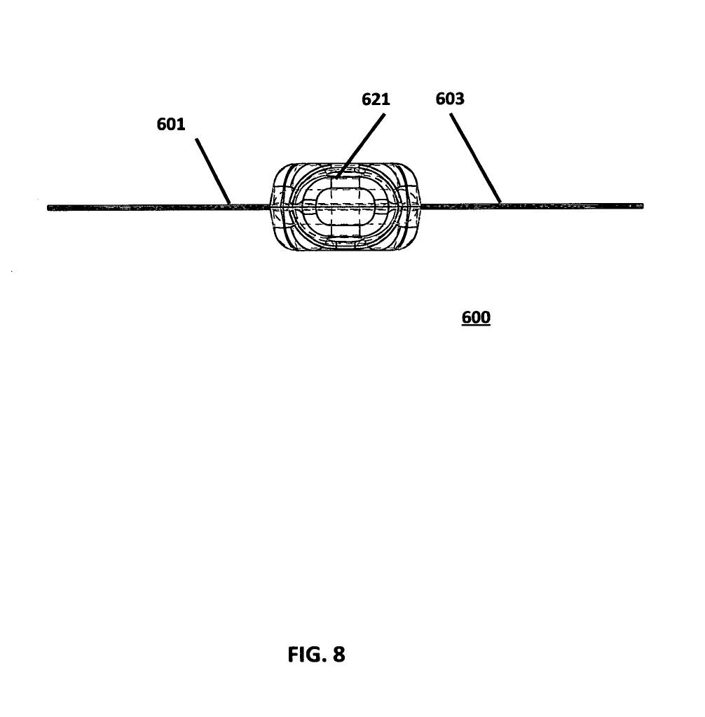

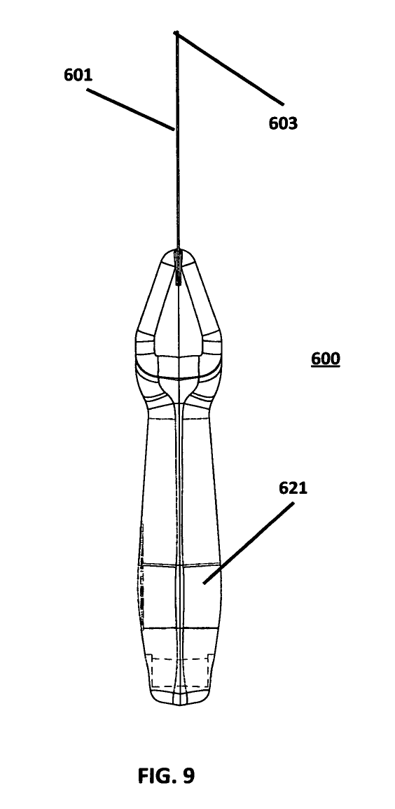

FIG. 8 is a top end view of the embodiment of FIG. 6;

FIG. 9 is a side view of the embodiment of FIG. 6; and

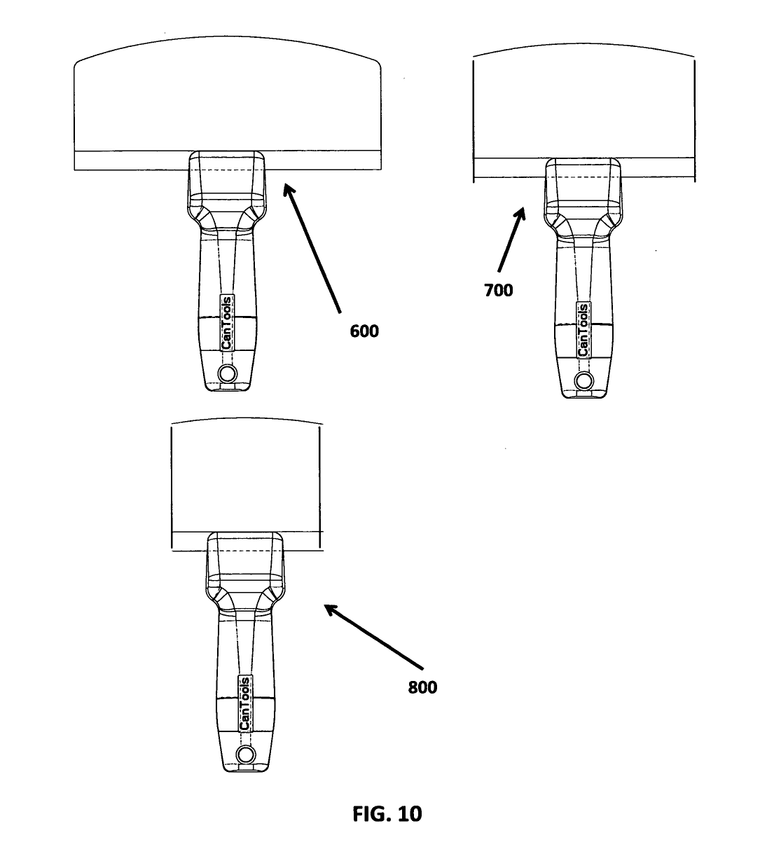

FIG. 10 is a planar view of a set of trowels in accordance with the principles of the invention.

### DETAILED DESCRIPTION

Turning now to FIGS. 6-9 a trowel 600 in accordance with the principles of the invention is shown. We refer to trowel 600 as “The Dome Trowel™.” Trowel 600 is a flexible arched knife-edge trowel used in the application of various materials to flat, concave and convex surfaces. Dome Trowel 600 overcomes the inadequacies of prior art trowels for the application of materials on concave and convex surfaces.

Trowel 600 comprises a relatively flexible sheet of material as a trowel blade 601. Trowel blade 601 is a material of a type having a memory property tending to maintain the sheet in a planar configuration. The material may be any one of a number of available materials utilized for flexible devices, including, but not limited to stainless steel, spring steel, plastic and other such materials.

Trowel blade 601 has a leading edge 603, a trailing edge 605, a first side edge 607 and a second side edge 609. Side edges 607, 609 connect the leading edge 603 and the trailing edge 605. Leading edge 603 is arcuate between the first and second side edges 607, 609. Trowel 600 further comprises a handle 621 coupled to the trowel blade 601 at the trailing edge 605.

Leading edge 603 comprises rounded end portions 611, 613 adjacent each of the first and second side edges 607, 609.

Leading edge 603 is convex with an arc of a predetermined radius r over substantially the entire length of leading edge 603. Radius r is selected to provide a smooth finish over a wide range of curved surfaces. In the embodiment of the invention, the radius is 12 inches. However, it will be appreciated by those skilled in the art that the radius may be greater than or less than the radius of the embodiment.

Trowel blade 601 comprises thin stainless steel. Blade 601 is laser cut to provide leading edge 603.

Handle 621 may vary in size or shape from that shown and may be of any of a number of various materials, including, but not limited to rubber, plastic and wood. In the embodiment shown, handle 621 comprises a high impact plastic such as high impact polystyrene that is molded onto trowel blade 601.

Convex leading edge 603 may be beveled to further improve the application of materials.

FIGS. 6-9 illustrate trowel 600 with an 8-inch wide working surface. Advantageously a set of trowels 600, 700, 800 as shown in FIG. 10 may be provided which have different widths. As will be appreciated by those skilled in the art, different width trowels are frequently used to work a surface. Although only three widths are shown in FIG. 10, it will be appreciated that a set of the trowels may include more or less trowels of varying width. By way of non-limiting example, a set may include trowels that are 2 inches, 4 inches, 8 inches, 12 inches, and 16 inches in width.

Although the shape of the working surface of trowel blade 601 is shown as generally rectangular with rounded corners and a convex leading edge 603, it will be apparent to those skilled in the art that side edges 607, 609 may angle toward trailing edge 605 at an acute angle or may be curved inward toward trailing edge 603.

It will be apparent to those skilled in the art that the trowel blade may be manufactured by stamping, casting (molding) and machining.

Trowel 600 has a trowel blade width of 3.5 inches, a length of 8 inches, a leading edger radius of 12 inches, a handle length of 5 inches, handle width of 2 inches and a handle thickness of 1.1 inches. All dimensions are approximate. Handle 621 is comprised of plastic, but in other embodiments may be of a different material such as, but not limited to rubber, wood or plastic. Handle 621 may have a hole so that it can be hung and displayed. Handle 621 may be one solid piece or two pieces that attach or mount on either side of the trowel.

The present invention provides a trowel that is designed for even application of materials on flat, concave or convex surfaces. Because of its unique design users will find that every inch of the trowel's working surface can be used to perform skilled application of materials to any surface using, but not limited to, faux, tiling, stenciling, and drywall techniques in the interior and exterior of building and decorating buildings.

The invention has been described in terms of specific embodiments. It will be apparent to those skilled in the art that various changes and modifications may be made to the embodiments without departing from the spirit or scope of the invention. It is not intended that the invention be limited to the embodiment shown and described herein. Rather it is intended that the invention be given the broadest permissible scope under the patent laws and it is intended that the invention be limited in scope only by the claims appended hereto or later added.

What is claimed is:

1. A trowel for working a curved surface, said trowel comprising:
a relatively flexible sheet of material having a memory property tending to maintain said sheet in a planar configuration, said sheet having a leading edge, a trailing edge and first and second side edges connecting said leading edge and said trailing edge, said leading edge being arcuate between said first and second side edges; and
a handle, said handle being coupled to said sheet at said trailing edge.

2. A trowel in accordance with claim 1, wherein:
said leading edge comprises rounded end portions adjacent each of said first and second side edges.

3. A trowel in accordance with claim 1, wherein:
said leading edge has an arc of a predetermined radius over substantially the entire length of said leading edge.

4. A trowel in accordance with claim 1, wherein:
said material comprises steel.

5. A trowel in accordance with claim 4, wherein:
said material is laser cut to provide said arcuate leading edge.

6. A trowel in accordance with claim 5, wherein:
said leading edge comprises rounded end portions adjacent each of said first and second side edges.

7. A trowel in accordance with claim 5, wherein:
said leading edge has an arc of a predetermined radius over substantially the entire length of said leading edge.

8. A trowel in accordance with claim 7
said leading edge has an arc of a first predetermined radius over substantially the entire length of said leading edge and end portions each having a second predetermined radius selected to be substantially shorter than said first predetermined radius.

9. A trowel in accordance with claim 4, wherein:
said handle comprises plastic material.

10. A trowel in accordance with claim 9, wherein:
said handle is molded onto said flexible sheet of material.

11. A trowel in accordance with claim 1, wherein:
said leading edge is beveled.

12. A set of trowels for working a curved surface, said set of trowels comprising:
a plurality of trowels, each of said trowels comprising:
a relatively flexible sheet of material having a memory property tending to maintain said sheet in a planar configuration, said sheet having a leading edge, a trailing edge and first and second side edges connecting said leading edge and said trailing edge, said leading edge being arcuate between said first and second side edges; and
a handle, said handle being coupled to said sheet at said trailing edge;
each of said trowels having a width between its corresponding first and second side edges that is different from the widths of the other ones of said plurality of trowels.

13. A set of trowels in accordance with claim 12, wherein:
said leading edge of each trowel comprises rounded end portions adjacent each of said first and second side edges.

14. A set of trowels in accordance with claim 12, wherein:
said leading edge of each said trowel has an arc of a predetermined radius over substantially the entire length of said leading edge.

15. A set of trowels in accordance with claim 12, wherein:
said material comprises steel.

16. A set of trowels in accordance with claim 12, wherein:
said material is laser cut to provide said arcuate leading edge.

17. A set of trowels in accordance with claim 12, wherein:
said leading edge has an arc of a first predetermined radius over substantially the entire length of said leading edge and end portions each having a second predetermined radius selected to be substantially shorter than said first predetermined radius.

18. A trowel for working a curved surface, said trowel comprising:
a relatively flexible sheet of material having a memory property tending to maintain said sheet in a planar configuration, said sheet having a leading edge, a trailing edge and first and second side edges connecting said leading edge and said trailing edge, said leading edge being arcuate between said first and second side edges with a predetermined radius selected to facilitate working a dome surface; and
a handle, said handle being coupled to said sheet at said trailing edge.

19. A trowel in accordance with claim 18, wherein:
said leading edge of each trowel comprises rounded end portions adjacent each of said first and second side edges.
